(19) United States
(12) Patent Application Publication
(10) Pub. No.: US 2009/0145884 A1
(43) Pub. Date: Jun. 11, 2009

(54) FORMING DEVICE AND METHOD FOR FORMING

(76) Inventors: Thomas AMMANN, Munchen (DE); Laurentius DRESSEL, Schweitenkirchen (DE)

Correspondence Address: The BOC Group, Inc., 575 MOUNTAIN AVENUE, MURRAY HILL, NJ, 07974-2082, US

(21) Appl. No.: 12/327,062

(22) Filed: Dec. 3, 2008

(30) Foreign Application Priority Data
Dec. 6, 2007 (DE) 102007058804.8

(51) Int. Cl. B23K 35/38

(52) U.S. Cl. 219/74

(57) ABSTRACT

In order to additionally develop a forming device for delivering at least one root shielding gas to the root side of at least one region to be joined of at least one object, as well as a corresponding method, such that discolorations and the formation of coatings on the object to be joined are effectively prevented, the invention proposes that the delivered root shielding gas is directed, and guided or deflected in the direction along the root side of the region to be joined.

### CROSS REFERENCE TO RELATED APPLICATION

This application claims priority under 35 USC §119 to German Patent Application DE 102007058804.8 filed in the German Patent and Trademark Office on Dec. 6, 2007.

### BACKGROUND OF THE INVENTION

The present invention pertains to a forming device and to a method for forming or for delivering at least one root shielding gas to the root side of at least one region to be joined of at least one object.

The term forming refers to the gassing or purging of the root side and the heat affected zone of a region to be joined with at least one root shielding gas. In this context, the area of the region to be joined that faces away from the joining device is referred to as the root side.

Furthermore, when joining a seam in several layers, the bottom layer and/or the layer formed first and, in a seam that is composed of one layer only, the section of the seam that faces away from the joining device are referred to as the root.

In the following description, the term joining comprises, in particular,
welding, especially all fusion welding methods, and, in particular, arc welding or beam welding methods (especially laser beam welding)
as well as arc brazing
and hybrid forms of welding and brazing.

In the present context, the term root shielding gas is used for your root shielding gas is, as well as for root shielding gas mixtures.

In forming processes, the root shielding gases used usually consist of argon or low-activity gases such as nitrogen, as well as mixtures of nitrogen and hydrogen (forming gases according to DIN EN 439) or argon and hydrogen. In this case, the root shielding gas is chosen in dependence on the materials to be processed, on the components, on the type of root shielding gas delivery and on the joining conditions. Root shielding gases simplify the sound root information of the seam, improve the surface quality of the root and prevent the formation of scale and tempering colors in the joint region.

The function of the root shielding gas during the forming process consists of displacing the oxygenous atmosphere and producing a high-quality surface. When joining corrosion-resistant work pieces such as, for example, stainless steel, the seam and the seam zones oxidize under an unhindered inflow of atmospheric oxygen due to the joining heat in connection with the atmospheric oxygen such that tempering colors appear.

Since the corrosion resistance of oxidized surfaces is significantly lowered, it is important to realize a sufficient gas shield, particularly on the root side, when joining objects of stainless steel. The present invention therefore pertains, in particular, to the shielding of the root while joining constructions of stainless steel, primarily while joining pipelines of stainless steel. However, the present invention also pertains to the shielding of a root when joining other materials.

Forming prevents the appearance of tempering colors, as well as oxidation in the region to be joined, by utilizing root shielding gas, if applicable, in connection with a technical device or a so-called forming device. Examples of forming devices according to the prior art for joining pipelines are illustrated in FIG. 3, FIG. 4 and FIG. 5.

These known forming devices usually deliver the root shielding gas directly to the joint with a suitable arrangement of sealing lips and diffusers within the pipe and keep the joint clear of atmospheric oxygen. When welding pipelines of stainless steel, forming devices are used in order to block off a short section of the pipe and to fill this section with the root shielding gas such that undesirable oxidation of the seam on the root side is prevented or at least reduced and tempering colors are inhibited.

The main advantages of a forming device are gas savings and an efficient shielding of the seam. In order to obtain corrosion-resistant joint seams, the residual oxygen content on the root side preferably is reduced to no more than about thirty parts per million (ppm).

Conventional forming devices are described, for example, in DVS-bulletin 0937 “Root Shielding during Inert Gas Welding,” DVS Publishing, Dusseldorf, 1990. Additional information on forming devices is provided by the firms Ind. Schweiβtechnik E. Jankus GmbH, Hoizwickede (DE), and Walter Schnorrer, Aalborg (DK), as part of their respective Internet presence under http://www.ja-online.de/ and http://www.schnorrer.dk/. Furthermore, a conventional forming device is disclosed as part of the prior art, for example, in publication DE 20 2005 021 175 U1.

Conventional forming devices are based on two different principles: either the space to be purged is completely flooded with root shielding gas (see FIG. 3), in which case slow flow velocities predominate, or the root shielding gas is directly blown against the seam in the radial direction (see FIG. 4 and FIG. 5). Although this ensures that the oxygen content is reduced to the required level directly on the seam, discolorations frequently appear at the joints.

When using a conventionally flowing forming device, no tempering colors as such appear during the joining process; the formation of chromium oxide therefore is effectively prevented. However, yellowish-brown discolorations, the cause of which has largely remained unknown so far, appear despite minimal oxygen content.

These discolorations are characterized in that they predominantly occur adjacent to the seam and occasionally also on the seam. These discolorations may even appear during a perfect formation in the technical sense, i.e., at 0 ppm residual oxygen content. However, chromium oxides, i.e., tempering colors as such, appear in the form of a succession of colors that already begins on this seam bead itself and is always created under the influence of oxygen, CO₂ or moisture. These discolorations or coatings influence the result of the joining process and, depending on the respective requirements, can lead to complaints.

### SUMMARY OF THE INVENTION

Based on the above-described disadvantages and deficiencies, as well as with consideration of the outlined prior art, the present invention aims to additionally develop a forming device of the initially described type, as well as a method of the initially described type, such that discolorations and the formation of coatings on the object to be joined are effectively prevented.

This objective is attained with a forming device with the of a forming device for delivering at least one root shielding gas to the root side of at least one region to be joined of at least one object characterized in at least one root shielding gas guiding device for guiding or for directing the delivered root shielding gas in the direction along the root side of the region to be joined and with a method for forming or for delivering at least one root shielding gas to the root side of at least one region to be joined of at least one object characterized in that the delivered root shielding gas is directed, guided or deflected in the direction along the root side of the region to be joined. Advantageous embodiments and practical additional developments of the present invention are characterized in the respective dependent claims.

Consequently, the present invention is based on the principle of directing a root shielding gas flow along the root side of the region to be joined, particularly
in the axial direction referred to the object and/or
in a plane that essentially lies parallel to the region to be joined of the object,
   for example, along the inner wall of the pipe to be joined.

The root shielding gas consequently is directed along a surface of the object (that may, in principle, have any shape), for example, along and/or transverse to the seam. The present invention therefore can be distinguished from the prior art in that the root shielding gas does not flow turbulently and not toward the seam or toward the root side, i.e., not radial or normal referred to the seam or the root side, respectively. In this case, the root shielding gas flows in any direction referred to the seam; consequently, it may flow along and/or transverse to the seam. The root shielding gas flow advantageously has a component transverse to the seam in this case.

Due to this directed root shielding gas flow, vapors that could possibly escape from the parent material of the object, for example from the pipe material, are carried away from the joint or from the region to be joined such that these vapors cannot deposit in the region of the seam. The invention therefore ensures a metallically blank seam formation without any discoloration, i.e., without tempering colors (chromium oxides) and without discolorations and coatings.

These discolorations are presumably caused by material components or gas evolutions from the parent material that evaporate early and condense on the colder surfaces such that said discolorations or coatings are formed. These discolorations or coatings are prevented with the present invention such that blank seams are produced.

To this end, the root shielding gas delivered during the forming process is directed toward the root side in the direction along the root side in the region to be joined by means of at least one root shielding gas guiding device or by means of at least one suitable construction of the forming device. The root shielding gas may advantageously flow in the axial direction referred to the object, particularly in the axial direction referred to the region to be joined.

When joining objects that do not have an axis, the root shielding gas is advantageously directed in a plane that lies parallel to the region to be joined of the object at least in the area of the root side. In this case, it is decisive that the root shielding gas flows along the seam, but not toward the seam. The root shielding gas may flow along the seam longitudinally or laterally thereto, as well as longitudinally and laterally thereto. This means that a gap is advantageously formed between the root shielding gas guiding device and the object such that the root shielding gas can flow through the gap in the direction thereof.

In contrast to conventional forming devices and conventional forming methods, the root of the seam produced with the present device and with the present method contains absolutely no tempering colors and coatings, namely even under unfavorable conditions such as, for example, when welding a large region to be joined or a wide joint gap.

The root shielding gas preferably flows past the region to be joined, particularly the pipe wall to be joined, in the immediate vicinity thereof. For this purpose, the root shielding gas guiding device is arranged a short distance from the object to be joined or from the region to be joined, respectively. The distance between the object and the root shielding gas guiding device may amount to, for example, up to about seven mm, preferably up to about five mm, particularly up to about three mm. In this respect, it is advantageous to adjust this distance as small as possible while still providing sufficient space for the root of the seam.

Due to these measures, the root shielding gas can be directed through a root shielding gas guiding gap formed between the object and the root shielding gas guiding device. The smaller the root shielding gas guiding gap, the faster the root shielding gas flows past the region to be joined and removes the escaping vapors.

In one advantageous embodiment, the root shielding gas guiding device for guiding or for directing the delivered root shielding gas is arranged on the root side at least in the region to be joined such that the root shielding gas flows along the surface of the object and over the seam on the root side. Consequently, a root shielding gas guiding gap is created, through which the root shielding gas flows. In this case, the root shielding gas may flow over the seam longitudinally or laterally, as well as in the form of a combined longitudinal or lateral flow. If the object to be joined is plane at least in the region to be joined, the root shielding gas guiding device is advantageously arranged parallel to the object. The root shielding gas flows through the gap and has a flow direction that extends longitudinally, laterally or longitudinally and laterally.

For example, the root shielding gas guiding device may consist of a metal sheet that is arranged parallel to the region to be joined. At least one mounting element can be used as an implement for realizing the parallel arrangement of and for aligning and/or holding the root shielding gas guiding device. It is also possible to direct a flow of root shielding gas along the root side on complicated objects. In this case, the gas flows longitudinally and/or laterally referred to the joint seam. To this end, the inventive forming device is designed in such a way that a gap is formed between the root shielding gas guiding device and the work piece, wherein the root shielding gas flows through this gap along the root side. The gap width should be advantageously maintained as constant as possible in order to create a uniform flow.

In one particularly advantageous embodiment, the root shielding gas guiding device for guiding or for directing the delivered root shielding gas is arranged in the axial direction of the object at least in the region of the root side. In this case, the object to be joined advantageously consists of a pipe, for example, of stainless steel. The root side of the region to be joined is arranged on the inner wall of the pipe in this case. In this embodiment, the root shielding gas guiding device is advantageously designed for directing the root shielding gas past the root side in the form of an axial flow in the vicinity of the wall. For this purpose, the root shielding gas guiding device is spaced apart from the inner wall of the pipe, for example, by up to about seven millimeters, preferably up to about five millimeters, particularly up to about three millimeters.

The root shielding gas guiding device may be realized circularly, for example in a disk-like fashion. Alternatively, the root shielding gas guiding device may also be shaped similar to a cylinder or cup. The root shielding gas guiding device is advantageously arranged in the pipe in a sintered fashion, for example, by means of a centering element.

In another embodiment of the present invention, the root shielding gas guiding device is cooled, for example water-cooled, by means of at least one cooling device. The cooled root shielding gas guiding device is able to withstand a particularly high thermal stress as it may occur, for example, if the root shielding gas guiding device is positioned particularly close to the region to be joined, e.g., the pipe wall, in order to achieve an even better protective effect by means of the axial root shielding gas flow.

The present invention furthermore pertains to a root shielding gas guiding device for guiding or directing root shielding gas delivered by means of a forming device of the above-described type in the direction along the root side of the region to be joined, particularly in the axial direction referred to the object and/or in the direction of a plane that essentially lies parallel to the region to be joined of the object.

The present invention also pertains to the utilization of at least one root shielding gas for joining at least one object of stainless steel by means of a welding method, particularly arc welding and/or arc brazing, in at least one forming device of the above-described type and/or a method of the above-described type.

The present invention pertains, in particular, to the utilization of at least one root shielding gas during joining.

The root shielding gas used may consist, in particular, of argon or nitrogen or at least one other low-activity gas such as mixtures of nitrogen and hydrogen (forming gases according to DIN EN 439) or argon and hydrogen or other inert or low-activity gas mixtures such as, e.g., argon and/or nitrogen and/or hydrogen.

### BRIEF DESCRIPTION OF THE DRAWINGS

As mentioned above, different options are available for advantageously realizing and additionally developing the present invention. In this respect, we refer to the claims that are respectively dependent on Claim 1 and Claim 9, wherein other designs, characteristics and advantages of the present invention are described in greater detail below with reference to, among other things, the two embodiments illustrated in FIG. 1A to 2.

In these drawings:

FIG. 1A shows a schematic longitudinal section through a first embodiment of a forming device according to the present invention that is designed for use in the method according to the present invention;

FIG. 1B shows a schematic longitudinal section through a second embodiment of a forming device according to the present invention that is designed for use in the method according to the present invention;

FIG. 2 shows a schematic cross section through the forming device according to FIG. 1A and FIG. 1B, respectively;

FIG. 3 shows a schematic longitudinal section through a first embodiment of a forming device according to the prior art;

FIG. 4 shows a schematic longitudinal section through a second embodiment of a forming device according to the prior art, and

FIG. 5 shows a schematic longitudinal section through a third embodiment of a forming device according to the prior art.

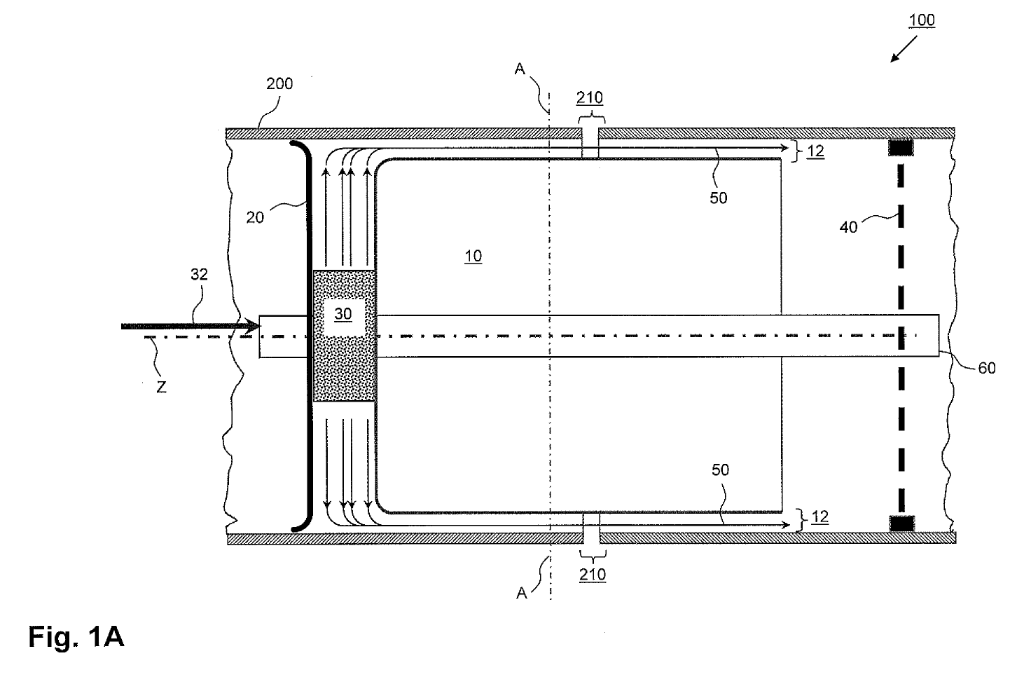

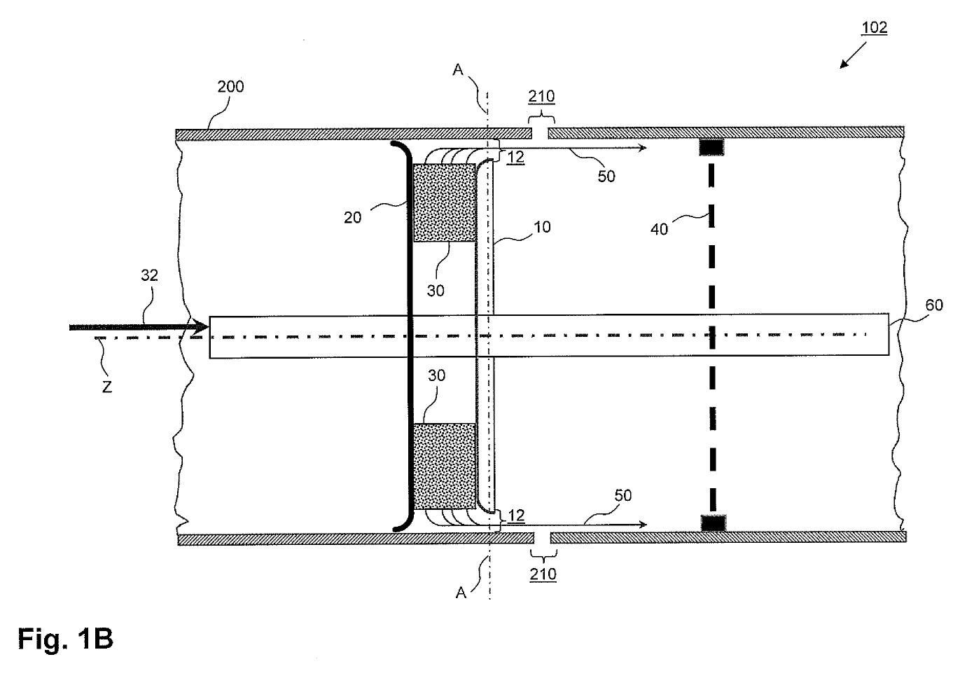

Identical or similar designs, elements or characteristics are identified by the same reference symbols in FIG. 1A to FIG. 5.

### DETAILED DESCRIPTION OF THE INVENTION

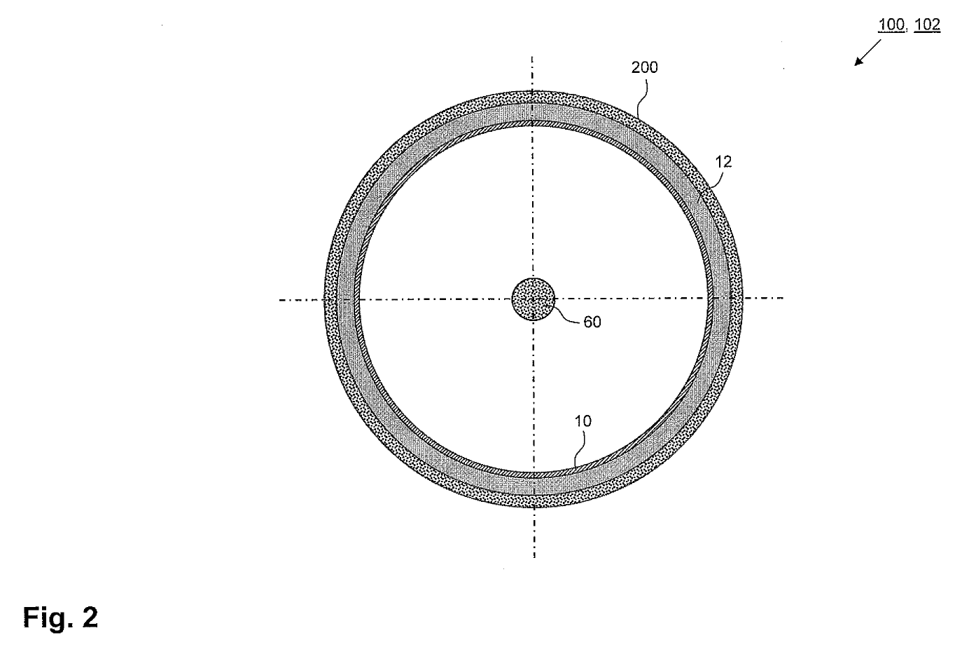

In order to avoid unnecessary repetitions, the following explanations apply (unless specified otherwise) to the first embodiment of a forming device 100 that is illustrated in FIG. 1A, FIG. 2, as well as the second embodiment of a forming device 102 that is illustrated in FIG. 1B, FIG. 2, with respect to the designs, characteristics and advantages of the present invention.

The forming devices 100, 102, 100′, 100″, 100′″ illustrated in FIG. 1A to FIG. 5 are designed for delivering a root shielding gas to the root side of a region 210 to be joined of an object 200, namely a pipe of stainless steel.

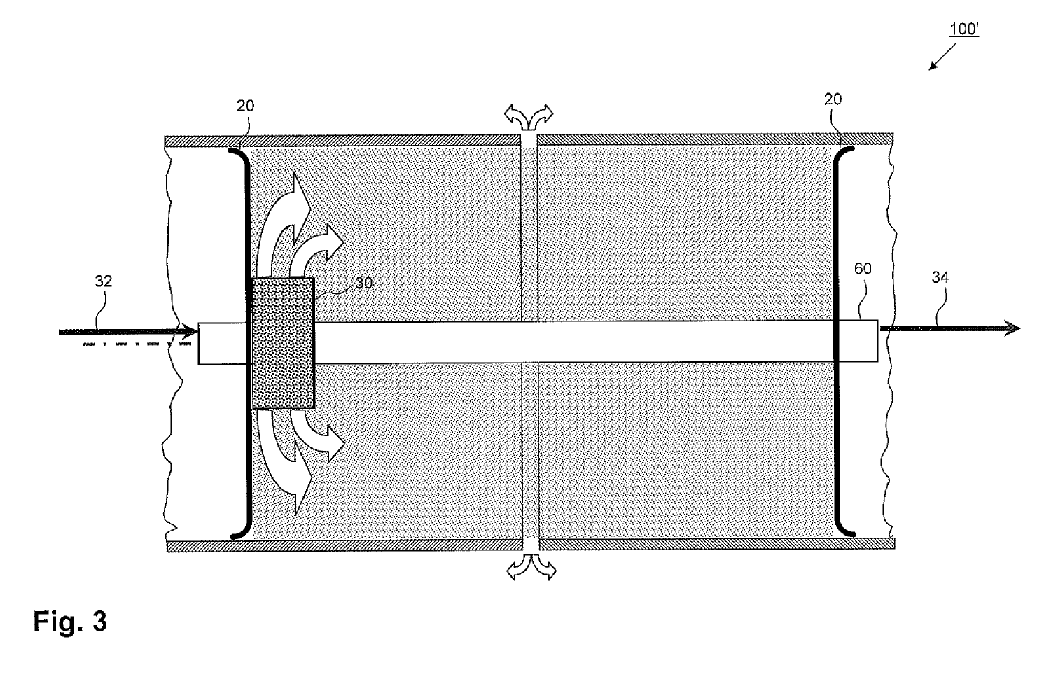

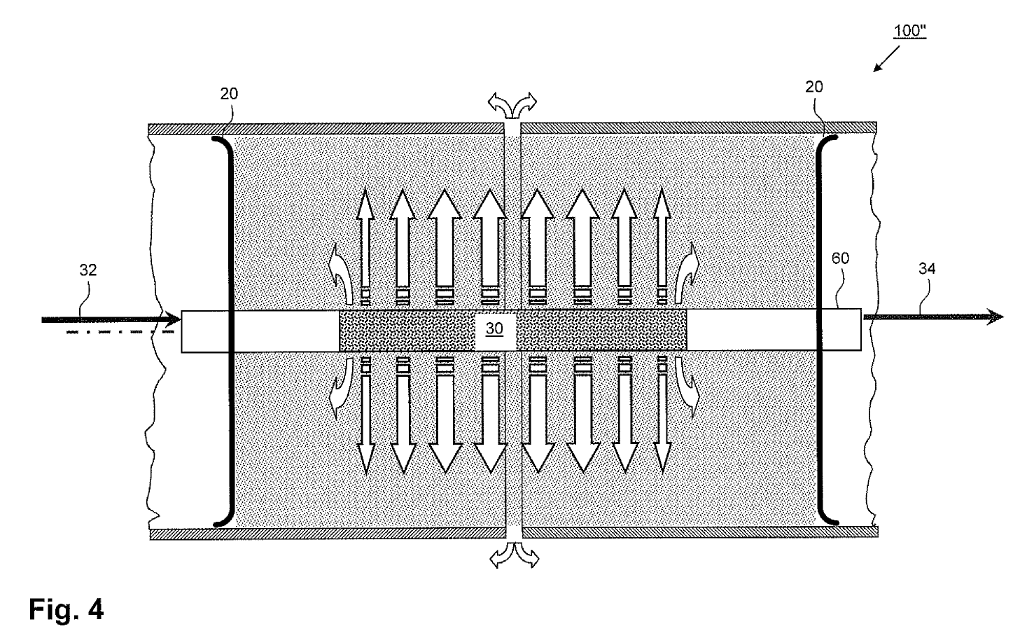

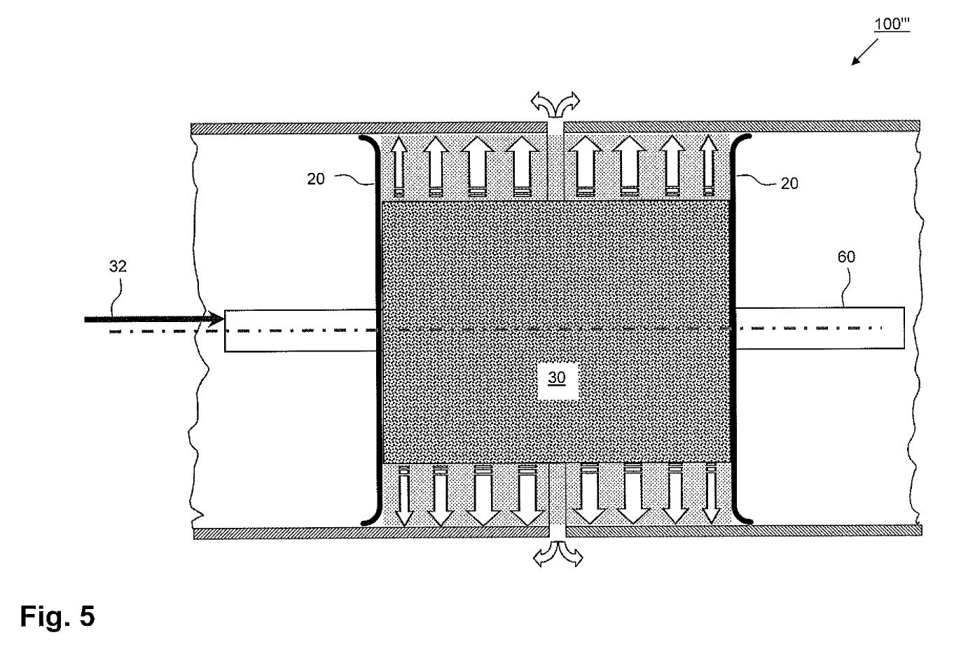

In the embodiments of a forming device 100′, 100″ and 100′″ according to the prior art that are respectively illustrated in FIG. 3, FIG. 4 and FIG. 5, the space to be purged is either completely flooded with root shielding gas (see FIG. 3) or the root shielding gas directly acts upon the seam in the radial direction (see FIG. 4 and FIG. 5). FIG. 3 shows a conventional forming device 100′ with diffuse gas flow.

FIG. 4 and FIG. 5 show conventional forming devices 100″ and 100′″ with a radial root shielding gas outlet. In the embodiment of a forming device 100′″ according to the prior art that is illustrated in FIG. 5, a root shielding gas delivery device 30 such as, for example, a sponge of sintered metal, extends over the entire length of the pipe element that is sealed with sealing elements or sealing lips 20, respectively.

The gas consumption of the embodiment of a forming device 100′″ according to the prior art that is illustrated in FIG. 5 is significantly lower than that of the embodiments of a forming device 100′ and 100″ according to the prior art that are illustrated in FIG. 3 and FIG. 4.

When using the conventional forming devices 100′, 100″ and 100′″ illustrated in FIG. 3, FIG. 4 and FIG. 5, however, yellowish-brown discolorations and coatings may form on the joined object due to vapors that escape during the joining process and precipitate on the object.

In the embodiments according to the prior art that are illustrated in FIG. 3 and FIG. 4, only a very slight and diffuse root shielding gas flow is produced in the vicinity of the pipe wall. Vapors escaping during the joining process therefore are not blown away by the root shielding gas. In the embodiment according to the prior art that is illustrated in FIG. 5, the diffuse flow is directed toward the pipe wall.

In contrast to the prior art, the delivered root shielding gas flows, according to the present invention, in the axial direction of the object 200 or in the axial direction referred to the pipe wall in the embodiments of an inventive forming device 100, 102 that are illustrated in FIG. 1A to FIG. 2. Vapors that escape during the joining process therefore are effectively carried away.

In the inventive embodiments 100, 102 illustrated in FIG. 1A to FIG. 2, the delivered root shielding gas is deflected by means of a root shielding gas guiding device 100 in such a way that an axial gas flow is created in the vicinity of the wall. In contrast to the prior art, the root shielding gas flows through the forming device 100, 102 in a laminar fashion in the present invention.

The present invention can furthermore be distinguished from the prior art in that the forming device 100, 102 according to one advantageous embodiment merely features a sealing lip 20 in the region of the root shielding gas inlet 32, particularly the root shielding gas delivery device 30.

In the embodiments 100, 102 illustrated in FIG. 1A to FIG. 2, a centering element 40 is arranged in the region of the root shielding gas outlet 34 in order to center the root shielding gas guiding device 10. Since the root shielding gas guiding device 10 is arranged in the pipe 200 in a centered fashion, a uniform root shielding gas guiding gap 12 is created between the root shielding gas guiding device 10 and the pipe wall 200. The centering element 40 is advantageously gas-permeable such that the axially flowing root shielding gas can be discharged from the forming device 100, 102 in an unobstructed fashion and no turbulences are created in the forming device 100, 102.

According to FIG. 1A and FIG. 1B, the root shielding gas can be delivered in a centered fashion by means of a root shielding gas delivery device 30 or at two or more locations by means of several root shielding gas delivery devices 30. It is merely required to deflect the root shielding gas by means of the root shielding gas guide 10 such that it axially flows along the wall of the pipe.

To this end, the root shielding gas guide 10 may be realized, for example, similar to a cup or a cylinder and form a long root shielding gas guiding gap 12 (see FIG. 1A); for example, the root shielding gas guide 10 may have a length of about 17 centimeters.

In an alternative embodiment, for example, with short pipelines, the root shielding gas guide 10 may, however, also be realized relatively short, for example in a disk-shaped or plate-shaped fashion (see FIG. 1B).

The forming device 100, 102 illustrated in FIG. 1A to FIG. 2 is intended for use in a straight pipe 200. According to one advantageous additional development of the present invention, the forming device may, however, also be designed for use in a bent or curved pipe or pipe section, respectively. In this case, it is also important to create an axial flow of the root shielding gas in the vicinity of the wall.

FIG. 2 shows a schematic section through the forming device 100, 102 along the line of section A-A indicated in FIG. 1A and FIG. 1B.

The results of tests carried out while processing the same parent material (→in order to thusly preclude an influence of the parent material) showed that virtually no discolorations or coatings are formed when using the inventive forming device 100, 102 while distinct yellow-brown discolorations appear adjacent to the joint seam when conventional forming devices 100′, 100″, 100′″ are used.

### LIST OF REFERENCE SYMBOLS

100 Forming device according to the present invention
   (=first embodiment; see FIG. 1A, FIG. 2)
102 Forming device according to the present invention
   (=second embodiment; see FIG. 1B, FIG. 2)
100′ Forming device according to the prior art
   (=first embodiment; see FIG. 3)
100″ Forming device according to the prior art
   (=second embodiment; see FIG. 4)
100′″ Forming device according to the prior art
   (=third embodiment; see FIG. 5)
10 Root shielding gas guiding device, particularly root shielding gas guide, for example, of sheet steel
12 Root shielding gas guiding gap between object 200 and root shielding gas guiding device 10
20 Sealing element, particularly sealing lip
30 Root shielding gas delivery device, particularly diffusor, for example, of sintered metal
32 Root shielding gas inlet
34 Root shielding gas outlet
40 Centering element
50 Direction of the flow of root shielding gas and/or direction along the root side of the region 210 to be joined, particularly axial direction of the object 200 and/or a plane that essentially lies parallel to the region 210 to be joined of the object 200
60 Guiding element, particularly for guiding the root shielding gas guiding device 10, the sealing element 20, the root shielding gas delivery device 30 and/or the centering element 50
200 Object to be joined, particularly pipe to be joined, for example of stainless steel
210 Region to be joined, particularly to be welded and/or to be brazed, of the object 200
A Plane of section
Z Central longitudinal axis of object 200

Having thus described the invention, what we claim is:

1. A forming device for delivering at least one root shielding gas to the root side of at least one region to be joined of at least one object), characterized in at least one root shielding gas guiding device for guiding or for directing the delivered root shielding gas in the direction) along the root side of the region to be joined.

2. The forming device according to claim 1, characterized in that the direction along the root side of the region to be joined extends in the axial direction of the object and/or in a plane that essentially lies parallel to the region to be joined of the object.

3. The forming device according to claim 1, characterized in that the root shielding gas guiding device is spaced apart from the object to be joined, particularly in a uniform fashion, and designed for directing the root shielding gas through a root shielding gas guiding gap formed between the object and the root shielding gas guiding device) and arranged, in particular, on the region to be joined essentially parallel to the object.

4. The forming device according to claim 1, characterized in that the object consists of a pipe, in that the root side of the region to be joined is arranged on the inner wall of the pipe, and in that the root shielding gas guiding device is designed for directing the delivered root shielding gas along the inner wall of the pipe in the region of the root side.

5. The forming device according to claim 4, characterized in that the root shielding gas guiding device has a circular shape similar to a cylinder or cup and/or can be inserted into the pipe in a centered fashion.

6. The forming device according to claim 4, characterized in at least one sealing element that can be inserted into the pipe in order to at least partially seal the delivered root shielding gas relative to the surroundings of the pipe and/or at least one centering element that is realized, in particular, in a gas-permeable fashion and can be inserted into the pipe in order to center the root shielding gas guiding device.

7. The forming device according to claim 1, characterized in at least one root shielding gas delivery device, particularly at least one diffusor, that is arranged, in particular, between the sealing element and the root shielding gas guiding device and serves for delivering the root shielding gas, wherein the root shielding gas delivery device cooperates with the root shielding gas guiding device in such a way that the delivered root shielding gas flows in the direction along the root side of the region to be joined at least in the region of the root side.

8. The forming device according to claim 1, characterized in at least one cooling device for cooling the root shielding gas guiding device, particularly by means of water.

9. The forming device according to claim 1, characterized in that said forming device is used for a method of joining selected from the group consisting of arc welding and arc brazing.

10. A method for forming or for delivering at least one root shielding gas to the root side of at least one region to be joined of at least one object, characterized in that the delivered root shielding gas is directed, guided or deflected in the direction along the root side of the region to be joined.

11. The method according to claim 10, characterized in that the delivered root shielding gas is directed, guided or deflected in the axial direction of the object and/or in a plane that essentially lies parallel to the region to be joined of the object at least in the region of the root side.

12. The method according to claim 10, characterized in that argon, nitrogen and/or hydrogen are used as root shielding gas.
